(19) United States
(12) Patent Application Publication
(10) Pub. No.: US 2006/0048126 A1
(43) Pub. Date: Mar. 2, 2006

(54) Method and a system thereof for generating a homepage content file capable of dynamically linking with a plurality of on-demand knowledge bases

(76) Inventor: Kui-Chang Sun, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/842,532

(22) Filed: May 11, 2004

(51) Int. Cl. G06F 9/44

(52) U.S. Cl. 717/162

(57) ABSTRACT

A method and a system thereof for generating a homepage content file capable of dynamically linking with a plurality of on-demand knowledge bases has an object to improve the faults of a conventional homepage which must be set in advance before linking, difficult to modify, and unable to dynamically select a knowledge content linked. This system comprises a corpus storage device for processing data content comprehension and a knowledge base content storage device for processing and providing linked knowledge. The knowledge base and corpus are managed by matching. When the user creates a knowledge base content, the system automatically generates a corresponding corpus. And when the user inputs a flat homepage data file and a selected linked knowledge base, the system automatically check the used corpus and performs a content comprehension to generate a spatial homepage data file having the selected knowledge linkage, and while the spatial homepage file is browsed, the knowledge to be linked can be dynamically selected for performing knowledge linkage.

### BACKGROUND OF THE INVENTION

1. Field of the Invention

The present invention relates to a method and a system thereof for generating a homepage content file capable of dynamically linking with a plurality of on-demand knowledge bases. The system designed is particularly directed to process Chinese natural language data in order to solve the problems that difficult to set and modify a content linkage in a homepage data as well as unable to dynamically link a selected knowledge content.

2. Description of the Prior Art

For currently familiar homepage data, when the user is intended to create a data content and a linked knowledge, must prepare a knowledge content in advance and set linkage information using specific words manually during producing a homepage data file. If the knowledge base content is modified, must carry out the adjustment manually, which time-consuming and labor-exhausting. And furthermore the existing homepage information linkage is unable to link multiple various knowledge contents at the same time or to select the linked knowledge content dynamically. There is a must to activate a knowledge query system and input a knowledge query condition so as to know whether the related knowledge existing in the knowledge base, which is resource-consuming and inconvenient and less effect; that will limit the knowledge management operation and application.

### SUMMARY OF THE INVENTION

In view of the above-mentioned faults, the object of the present invention is to provide a method and a system thereof for generating a homepage content file capable of dynamically linking with a plurality of on-demand knowledge bases. One of the features of the system is to use the common vocabularies of a corpus as the basis for content segmentation, and then use a specialized vocabulary to set a linkage, thus to raise the accuracy of comprehension, and the words in a corpus will automatically increase/decrease to tie in with the knowledge base. Another feature of the present invention is that the linkage information generated by the system of the present invention can link multiple knowledge bases simultaneously or a dynamic specified knowledge base. A further feature is that the knowledge base and homepage data may be separately created, to enable the user to run linkage processing as required, so that the problems of setting and modifying data linkage inconveniently and the inconsistency between a content and a knowledge base can be solved.

### BRIEF DESCRIPTION OF THE DRAWINGS

The drawings disclose an illustrative embodiment of the present invention which serves to exemplify the various advantages and objects hereof, and are as follows:

For illustrating the other objects and advantages of the present invention, now the following drawings tied in with the description of the preferred embodiments are shown as follows, wherein

FIG. 1 shows a block diagram of the system architecture according to the present invention;

FIG. 2 shows a flow chart for a data content generating a related knowledge linkage according to a method of present invention;

FIG. 3 shows a flow chart for creating a common vocabulary according to the present invention;

FIG. 4 shows a flow chart for creating a linked knowledge according to the present invention; and

FIG. 5 shows a flow chart for dynamic knowledge linkage according to the present invention;

### REPRESENTATIVE SYMBOLS OF MAIN COMPONENTS

1—data input device
2—central processing unit (CPU)
3—corpus
31—common thesaurus storage device
32—specialized thesaurus storage device
4—knowledge base content storage device
5—data access control device
6—data output device
20—input the homepage file for linking knowledge and the name of the knowledge base
21—Analyzing a homepage content
22—Analyzing a corpus and creating a knowledge linkage
23—Generating an output of a knowledge linkage file
30—Input a pending common vocabulary
33—Check a common vocabulary
34—Create a common thesaurus
40—Input a pending knowledge content
41—Check a specialized vocabulary
42—Create a specialized thesaurus
43—Create a knowledge content
50—Selecting data
51—Selecting a linked knowledge base
52—Retrieving knowledge
53—Displaying related knowledge

### DETAILED DESCRIPTION OF THE PREFERRED EMBODIMENT

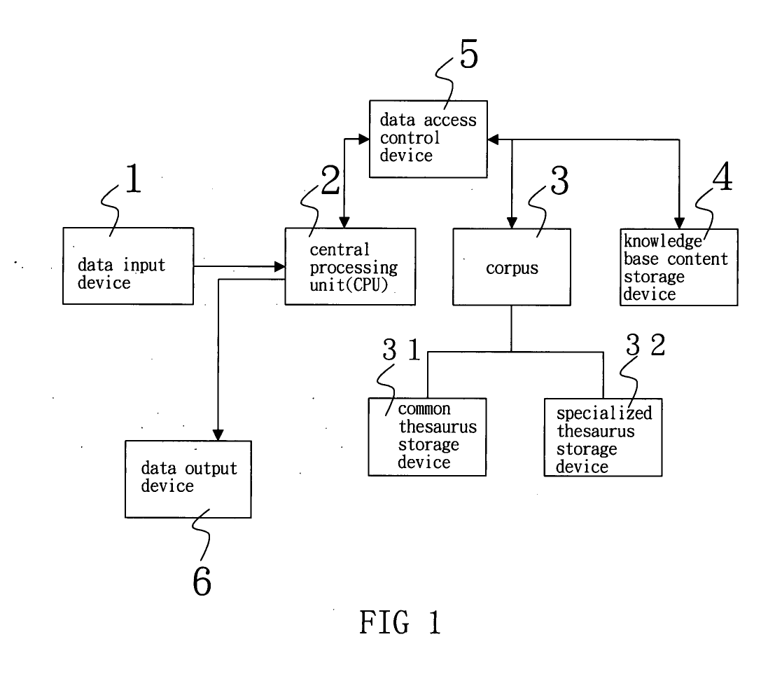

Please referring to FIG. 1, the on-demand knowledge linkage system of the present invention mainly comprises a data input device 1, a central processing unit (CPU) 2, a corpus 3, a knowledge base content storage device 4, a data access control device 5, and a data output device 6, wherein the corpus 3 is used to store data of a common thesaurus and a specialized thesaurus, data input from data input device 2 are categorized by types thereof into data of corpus or knowledge content, and then the central processing unit 2 tied in with the operation of the data access control device 5 stores the categorized data into a common thesaurus storage device 31 or a specialized thesaurus storage device 32 of a corpus 3 storage or a knowledge base content storage device 4 respectively.

To enable the data content linking with the relevant knowledge content dynamically selected by the user, the user must create a knowledge base first, one feature of the present invention is that the knowledge content volume can vary with time, and any specialized vocabulary can be created and modified at the same time so as to the corpus 3 and the knowledge base content storage device 4 can be consistently maintained during link data contents, and also can take into consideration that the word of a knowledge or the meaning of a word may differ in various fields. Thus, the present invention provides a mechanism for the user to adjust by him/herself to achieve more practical benefits from the linked knowledge content.

The input category of the knowledge content is determined by the user. Based on the property of the data, the central processing unit 2 stores the data into the storage which the category of the data belongs. This embodiment includes a corpus 3 except the knowledge base content storage device 4, the corpus 3 comprising a common thesaurus storage device 31 and a specialized thesaurus storage device 32. It should be noted that the present invention originate to automatically create a specialized thesaurus that used in the process of generating dynamic on-demand knowledge linkage information during the creation of knowledge content.

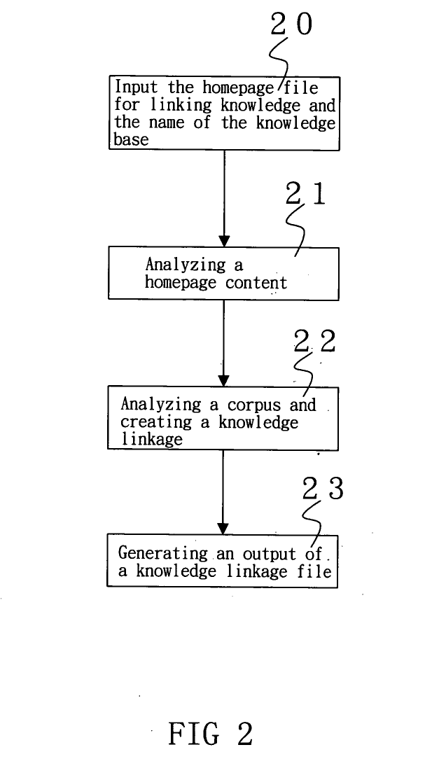

A method for generating a homepage content file capable of dynamically linking with a plurality of on-demand knowledge bases according to the present invention will be described with the block diagram of FIG. 2.

Please referring to FIGS. 1 and 2, the steps for generating knowledge linkage are as follows:
(1) Inputting a homepage data file to be processed: enter a homepage file for knowledge linkage and the name of a knowledge base 20 for linkage.
(2) Finding out vocabularies within said file from a common thesaurus storage device: the present invention using a central processing unit 2 to find out a corresponding specialized thesaurus storage device 32 based on the name of the knowledge base.
(3) Finding out specialized vocabularies from specialized thesaurus storage device based on the vocabularies found in step (2): again using the common thesaurus storage device 31, to find out the common vocabularies 21 in the homepage content.
(4) At the front and rear of the vocabulary found by step (3), adding a dynamic linking information and placing in the generated homepage file: reusing the specialized thesaurus storage device 32 to run “Analyzing a corpus and creating a knowledge linkage” 22, to sieve out the specialized content from the homepage file content, and then at the front and rear of the found vocabulary adding a dynamic linking information to generate a knowledge-linked file output 23.
(5) Outputting a homepage file after a one to many dynamic linking information generated: using data output device 6 to output.

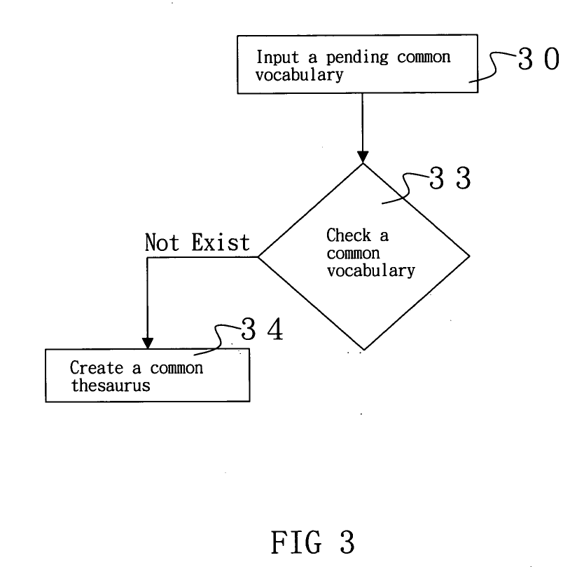

The content of the common thesaurus storage device 31 used in the present invention is capable of being established by the user him/herself. As regards to the creation flow, please refer to FIG. 3. For the user to input a pending common vocabulary 30, the present invention using the central processing unit 2 to run “Check a common vocabulary” 33 to check whether the common thesaurus storage device 31 exists said vocabulary, if not, running the step of “Create a common thesaurus” 34, and store said vocabulary in the common thesaurus storage device 31.

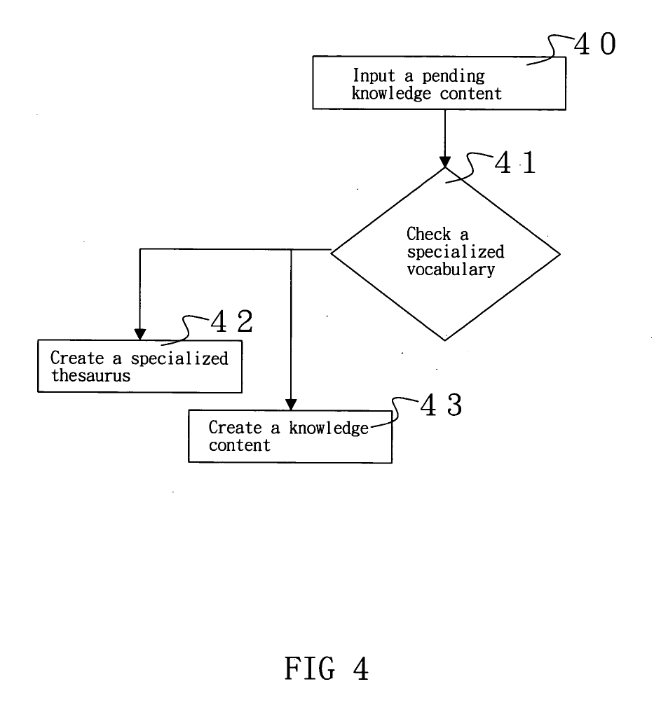

The generation of the content of the specialized thesaurus storage device 32 used in the present invention coordinates with “Create a knowledge content” 43, and the thesaurus has a 1-1 relationship with the knowledge base, i.e., each one knowledge base has a “Create a specialized thesaurus” 42 operation correspondingly, which is one of the features of the present invention. As a result of such a design, when the user performs a dynamic knowledge linkage, the sieving out of the content may vary with the selected knowledge base and generate various comprehension and linkages. Please refer the creation flow in FIG. 4, the user input a pending knowledge content 40, the present invention using the central processing unit 2 to run “Check a specialized vocabulary” 41 to check whether the knowledge name exists in the specialized thesaurus storage device 32, if not, then running “Create a specialized thesaurus” 42 to store the vocabulary into the specialized thesaurus storage device 32 and storing into the knowledge base content storage device 4 after “Create a knowledge content” 43.

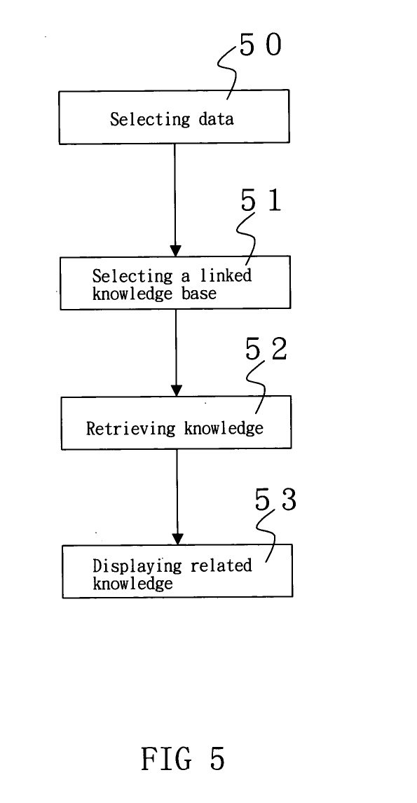

The method for dynamic knowledge linkage stream of the present invention, as shown in FIG. 5, is where the present invention differs with conventional techniques. Before running the linkage process, the user can select one or more knowledge bases to be linked and generate a on-demand knowledge linkage file, and the user again click the specialized vocabularies with knowledge linkages, thus can obtain the knowledge content chosen by those vocabularies, the steps are as follows:
(1) Inputting a homepage file that the dynamic linkage information has been generated.
(2) Selecting one or more knowledge bases to be linked: The user clicking the knowledge bases to be linked and running “Selecting data” 50.
(3) Clicking the specialized vocabularies having dynamic linkage information and indicated by the homepage content: Clicking the specialized vocabulary for obtaining knowledge and running “Selecting a linked knowledge base” 51.
(4) The system, based on the input specialized vocabulary, from the knowledge database storage devices (31, 32, and 4), finds out the knowledge content of the selected knowledge base respectively, and displaying the content in the output device respectively: that is, according to the specialized vocabulary and the knowledge bases input, using central processing unit 2 to run “Retrieving knowledge” 52 in the knowledge base content storage device, and outputting the knowledge content obtained from each selected knowledge base respectively and performing “Displaying related knowledge” 53 to provide the user information.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method for generating a homepage content file capable of dynamically linking with a plurality of on-demand knowledge bases, which comprising following steps:
(1) Categorizing a knowledge data content to be established and dividing the knowledge data content into a specialized vocabulary and a knowledge content data; and creating a knowledge base;
(2) Recording the specialized vocabulary data into a specialized thesaurus storage device, said data can be incorporated into the auto-generating operation of the one to many dynamic linkage information for processing;
(3) Recording the knowledge content data into a knowledge content storage device according to the name of a specialized vocabulary, said data can be incorporated into the knowledge linkage operation of the one to many on-demand knowledge base for processing;

2. The method of claim 1, wherein the method for the auto-generating operation of the one to many dynamic linkage information comprising following steps:
(1) Inputting a homepage data file to be processed;
(2) Finding out vocabularies within said file from a common thesaurus storage device;
(3) Finding out specialized vocabularies from specialized thesaurus storage device based on the vocabularies found in step (2);
(4) At the front and rear of the vocabulary found by step (3), adding a dynamic linking information and placing in the generated homepage file;
(5) Outputting a homepage file after a one to many dynamic linking information generated.

3. The method of claim 1, wherein the method for the knowledge linkage operation of the one to many on-demand knowledge base comprising following steps:
(1) Inputting a homepage file in which dynamic linkage information has been generated;
(2) Selecting one or more knowledge bases to be linked;
(3) Clicking the specialized vocabulary having dynamic linkage information and indicated by the homepage content;
(4) The system, based on the input specialized vocabulary, from the knowledge database storage devices, finds out the knowledge content of the selected knowledge base respectively, and displaying the content in the output device respectively.

4. A on-demand knowledge linking system of claim 1, which comprising a data input device, a central processing unit (CPU), a corpus, a knowledge base content storage device, a data access control device, and a data output device, wherein the corpus consisting of at least one common thesaurus storage device and at least one specialized thesaurus storage device;
using the corpus to store the data of the common thesaurus base and the specialized vocabulary base, the data input from the data input device first is categorized by the type thereof into a corpus data or a knowledge content data, and then using the central processing unit tied in with the operation of the data access control device, to store those three types of data into the common thesaurus storage device, the specialized thesaurus storage device of a corpus storage, and the knowledge base content storage device.
